(19) United States
(12) Patent Application Publication
(10) Pub. No.: US 2005/0185582 A1
(43) Pub. Date: Aug. 25, 2005

(54) Apparatus and method for managing traffic and quality of service in a high-speed router

(75) Inventors: Jack C. Wybenga, Plano, TX (US); Steven Eugene Tharp, Gerland, TX (US); Patricia Kay Sturm, McKinney, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/783,936

(22) Filed: Feb. 20, 2004

(51) Int. Cl. H04L 12/56

(52) U.S. Cl. 370/230

(57) ABSTRACT

A router for interconnecting external devices coupled to the router. The router comprises a switch fabric and a plurality of routing nodes coupled to the switch fabric. Each of the routing nodes transmits data packets to, and receives data packets from, the external devices and other routing nodes via the switch fabric. The switch fabric detects that the output bandwidth of a first output of the switch fabric has been exceeded and, in response to the detection, attempts to slow the input ports and drops lower priority packets if necessary. The routing nodes give precedence to routing higher priority packets.

### TECHNICAL FIELD OF THE INVENTION

The invention relates to massively parallel routers and, more specifically, to an apparatus and method for managing traffic and quality of service (QoS) in a massively parallel, distributed architecture router.

### BACKGROUND OF THE INVENTION

There has been explosive growth in Internet traffic due to the increased number of Internet users, various service demands from those users, the implementation of new services, such as voice-over-IP (VoIP) or streaming applications, and the development of mobile Internet. Conventional routers, which act as relaying nodes connected to sub-networks or other routers, have accomplished their roles well, in situations in which the time required to process packets, determine their destinations, and forward the packets to the destinations is usually smaller than the transmission time on network paths. More recently, however, the packet transmission capabilities of high-bandwidth network paths and the increases in Internet traffic have combined to outpace the processing capacities of conventional routers.

This has led to the development of a new generation of massively parallel, distributed architecture routers. A distributed architecture router typically comprises a large number of routing nodes that are coupled to each other via a plurality of switch fabric modules and an optional crossbar switch. Each routing node has its own routing (or forwarding) table for forwarding data packets via other routing nodes to a destination address.

When a switch or router switches data packet traffic from numerous input ports to numerous output ports, the distribution of traffic to a particular output port may easily exceed the bandwidth of the output port. It is desirable to allow prioritization of traffic, thereby giving priority (or precedence) to more important (i.e., higher cost) services. In addition, a service provider may sell a low-cost service that limits the bandwidth available to a subscriber to a level below the maximum port bandwidth. For example, a Gigabit Ethernet port may be sold to a particular user as a 10 Base-T (10 Mbps) connection, a 100-Base T (100 Mbps) connection, or a 1000 Base-T (1000 Mbps) connection. Providing support for different service levels enables a service provider to sell different levels of service at different prices. Although this bandwidth restriction may appear artificial (because the port can handle higher bandwidth), it may be done to reduce the load on other parts of the network.

Standards organizations have been defining framing formats that insert Class of Service (CoS), Quality of Service (QoS), Traffic Prioritization, and other traffic classification information in the framing and packet headers. For example, the IEEE 802.1p and IEEE 802.1q standards define traffic classification and prioritization for Ethernet frames. Also, the IETF and other organizations are in the process of defining prioritization schemes for IP services. Additionally, the ATM Forum has defined classification and prioritization schemes for ATM.

Although the frames and data packets carry the necessary information for traffic management, the mechanism for using this information to do the actual traffic management has not been defined by the standards organization. Due to the lack of practical traffic management mechanisms, conventional switches and routers typically do not perform traffic management.

Performing traffic shaping at the input ports and QoS functions at the output ports requires feedback from the output ports to the input ports in order to schedule inputs. Feedback is difficult to process in a non-distributed system and becomes nearly impossible to process in the current and next generation distributed routers and switches used to handle high-speed and high-capacity traffic. Thus, the feedback may lead to non-optimal use of available router (or switch) bandwidth. Feedback in distributed systems may lead to other problems, such as head-of-line (HOL) queuing problems and difficulty in providing information in a timely manner to keep up with traffic scheduling at the high line rates supported in current routers. Also, conventional systems often drop data traffic at the input ports early in the process (i.e., before the need to drop the data traffic is fully known). Delaying the dropping of data traffic until congestion actually occurs allows the switch or router bandwidth to be used more fully.

Therefore, there is a need in the art for improved routers and switches for routing data traffic. In particular, there is a need for a distributed architecture switch (or router) that does not require feedback from output ports to be sent back to input ports.

### SUMMARY OF THE INVENTION

The present invention manages data packet traffic in a packet switch or router. In particular, the present invention provides a practical mechanism for allowing traffic management in a high speed, fourth generation switch (or router). The present invention comprises a unique traffic engineering technique that uses Virtual Output Queuing to provide quality of service (QoS) that is constrained at the switch fabric, instead of at the port output. The present invention combines traffic shaping normally done at the input ports and QoS normally done at the output ports into a single process done at the switch fabric. Traffic shaping at the input ports is relegated to supporting subscription services for revenue purposes instead of being done in support of QoS.

To address the above-discussed deficiencies of the prior art, it is a primary object of the present invention to provide a router for interconnecting external devices coupled to the router. According to an advantageous embodiment of the present invention, the router comprises: 1) a switch fabric; and 2) a plurality of routing nodes coupled to the switch fabric, wherein each of the plurality of routing nodes comprises packet processing circuitry capable of transmitting data packets to, and receiving data packets from, the external devices and further capable of transmitting data packets to, and receiving data packets from, other ones of the plurality of routing nodes via the switch fabric. The switch fabric is capable of detecting that the output bandwidth of a first output of the switch fabric has been exceeded and, in response to the detection, the switch fabric causes a first one of the plurality of routing nodes to slow an input rate of data packets transmitted from the first routing node to a first input of the switch fabric.

According to one embodiment of the present invention, the switch fabric implements a Weighted Fair Queuing algorithm to slow the input rate of data packets from the first routing node.

According to another embodiment of the present invention, the first routing node comprises a first queue comprising a plurality of prioritized buffers capable of storing data packets to be transmitted to the switch fabric.

According to still another embodiment of the present invention, the first routing node slows down a rate at which data packets are transmitted to the switch fabric from the first queue.

According to yet another embodiment of the present invention, the first routing node selects data packets to be transferred to the switch fabric from a first one of the plurality of prioritized buffers according to a priority value associated with the first prioritized buffer.

According to a still further embodiment of the present invention, the first routing node causes a first one of the external devices to slow a rate at which data packets are transmitted to the first queue.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary distributed architecture router that performs quality of service (QoS) and traffic policing functions according to the principles of the present invention;

FIG. 2 illustrates selected portions of the distributed architecture router in FIG. 1 in an alternate view according to an exemplary embodiment of the present invention; and

FIG. 3 is a flow diagram illustrating traffic policing and QoS functions in the exemplary router according to an exemplary embodiment of the present invention.

### DETAILED DESCRIPTION OF THE INVENTION

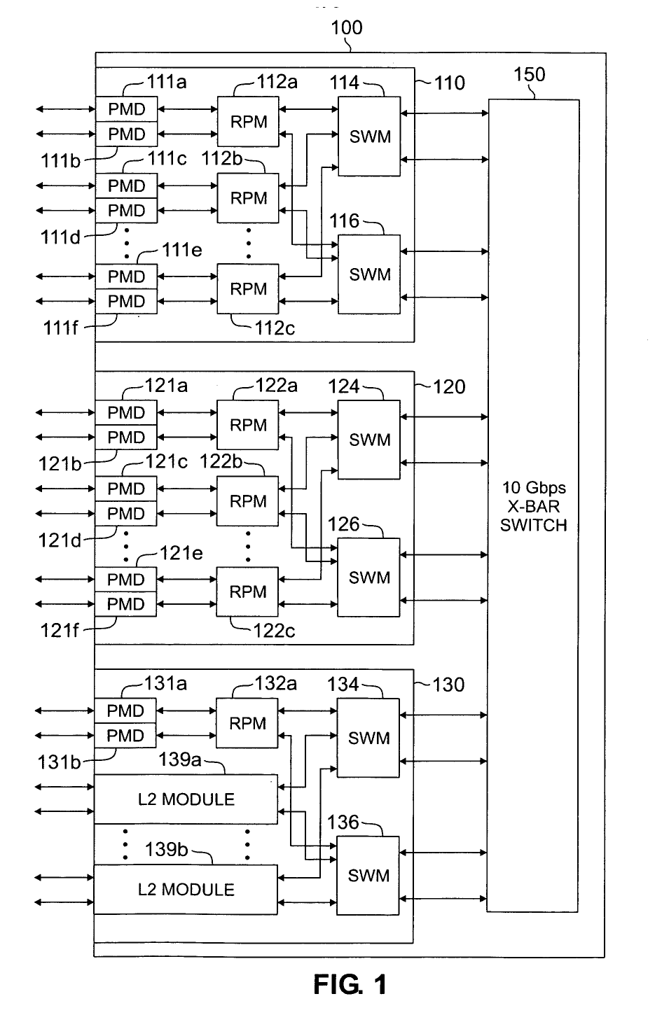

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged distributed packet switch or router.

FIG. 1 illustrates exemplary distributed architecture switch (or router) 100 (hereafter, simply “router 100”), which performs quality of service (QoS) functions and traffic policing functions according to the principles of the present invention. According to the exemplary embodiment, router 100 comprises a plurality of rack-mounted shelves, including exemplary shelves 110, 120, and 130, that are coupled via crossbar switch 150. In an advantageous embodiment, crossbar switch 150 is a 10 Gigabit Ethernet (10 GbE) crossbar operating at 10 gigabits per second (Gbps) per port.

Each of exemplary shelves 110, 120 and 130 may comprise route processing modules (RPMs) or Layer 2 (L2) modules, or a combination of route processing modules and L2 modules. Route processing modules forward data packets using primarily Layer 3 information (e.g., Internet protocol (IP) addresses). L2 modules forward data packets using primarily Layer 2 information (e.g., medium access control (MAC) addresses).

Exemplary shelf 110 comprises a pair of redundant switch modules, namely primary switch module (SWM) 114 and secondary switch module (SWM) 116, a plurality of route processing modules 112, including exemplary route processing module (RPM) 112a, RPM 112b, and RPM 112c, and a plurality of physical media device (PMD) modules 111, including exemplary PMD modules 111a, 111b, 111c, 111d, 111e, and 111f. Each PMD module 111 transmits and receives data packets via a plurality of data lines connected to each PMD module 111.

Similarly, shelf 120 comprises a pair of redundant switch modules, namely primary SWM 124 and secondary SWM 126, a plurality of route processing modules 122, including RPM 122a, RPM 122b, and RPM 122c, and a plurality of physical media device (PMD) modules 121, including PMD modules 121a-121f. Each PMD module 121 transmits and receives data packets via a plurality of data lines connected to each PMD module 121.

Additionally, shelf 130 comprises redundant switch modules, namely primary SWM 134 and secondary SWM 136, route processing module 132a, a plurality of physical media device (PMD) modules 131, including PMD modules 131a and 131b, and a plurality of Layer 2 (L2) modules 139, including L2 module 139a and L2 module 139b. Each PMD module 131 transmits and receives data packets via a plurality of data lines connected to each PMD module 131. Each L2 module 139 transmits and receives data packets via a plurality of data lines connected to each L2 module 139.

Router 100 provides scalability and high-performance using up to M independent routing nodes (RN). A routing node comprises, for example, a route processing module (RPM) and at least one physical medium device (PMD) module. A routing node may also comprise an L2 module (L2M). Each route processing module or L2 module buffers incoming Ethernet frames, Internet protocol (IP) packets and MPLS frames from subnets or adjacent routers. Additionally, each RPM or L2M classifies requested services, looks up destination addresses from frame headers or data fields, and forwards frames to the outbound RPM or L2M. Moreover, each RPM (or L2M) also maintains an internal routing table determined from routing protocol messages, learned routes and provisioned static routes and computes the optimal data paths from the routing table. Each RPM processes an incoming frame from one of its PMD modules. According to an advantageous embodiment, each PMD module encapsulates an incoming frame (or cell) from an IP network (or ATM switch) for processing in a route processing module and performs framing and bus conversion functions.

Incoming data packets may be forwarded within router 100 in a number of different ways, depending on whether the source and destination ports are associated with the same or different PMD modules, the same or different route processing modules, and the same or different switch modules. Since each RPM or L2M is coupled to two redundant switch modules, the redundant switch modules are regarded as the same switch module. Thus, the term “different switch modules” refers to distinct switch modules located in different ones of shelves 110, 120 and 130.

In a first type of data flow, an incoming data packet may be received on a source port on PMD module 121f and be directed to a destination port on PMD module 131a. In this first case, the source and destination ports are associated with different route processing modules (i.e., RPM 122c and RPM 132a) and different switch modules (i.e., SWM 126 and SWM 134). The data packet must be forwarded from PMD module 121f all the way through crossbar switch 150 in order to reach the destination port on PMD module 131a.

In a second type of data flow, an incoming data packet may be received on a source port on PMD module 121a and be directed to a destination port on PMD module 121c. In this second case, the source and destination ports are associated with different route processing modules (i.e., RPM 122a and RPM 122b), but the same switch module (i.e., SWM 124). The data packet does not need to be forwarded to crossbar switch 150, but still must pass through SWM 124.

In a third type of data flow, an incoming data packet may be received on a source port on PMD module 111c and be directed to a destination port on PMD module 111d. In this third case, the source and destination ports are associated with different PMD modules, but the same route processing module (i.e., RPM 112b). The data packet must be forwarded to RPM 112b, but does not need to be forwarded to crossbar switch 150 or to switch modules 114 and 116.

Finally, in a fourth type of data flow, an incoming data packet may be received on a source port on PMD module 111a and be directed to a destination port on PMD module 111a. In this fourth case, the source and destination ports are associated with the same PMD module and the same route processing module (i.e., RPM 112a). The data packet still must be forwarded to RPM 112a, but does not need to be forwarded to crossbar switch 150 or to switch modules 114 and 116.

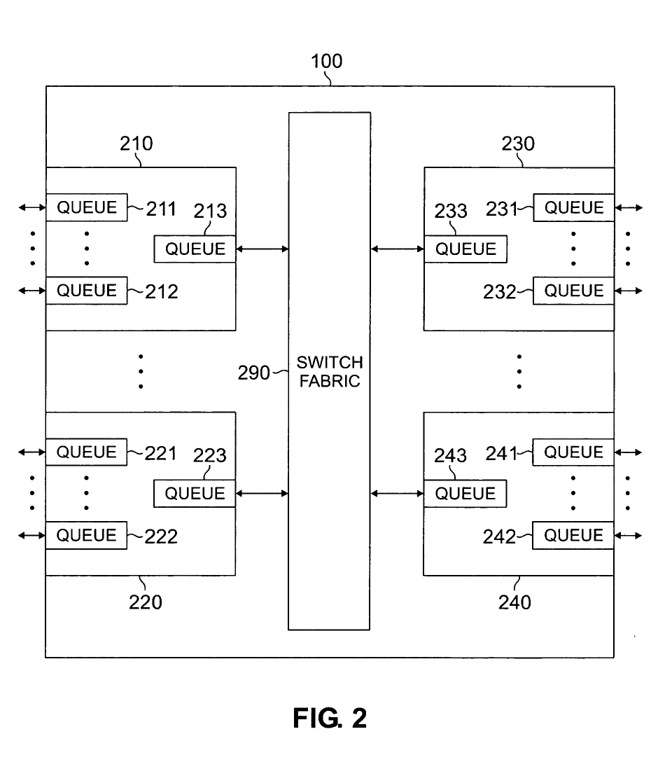

FIG. 2 is an alternate view of distributed architecture router 100 that illustrates selected components in router 100 in greater detail according to an exemplary embodiment of the present invention. In FIG. 2, the structure of shelves 110, 120, and 130 are not shown. Rather, the route processing modules (RPMs) and the Layer 2 modules (L2Ms) from shelves 110, 120, and 130 are represented generically as routing nodes 210, 220, 230 and 240. Additionally, crossbar switch 150 and the switch modules (SWMs) in shelves 110, 120, and 130 are collectively represented by switch fabric 290. Each one of routing node 210, 220, 230 and 240 comprises a plurality of prioritized queues that receive data packets from, and transmit data packets to, external devices or switch fabric 290. Each of the prioritized queues may comprise, for example, eight (8) levels of prioritized buffers.

Routing node 210 comprises N queues, including exemplary queues 211-213. In the exemplary embodiment, the N queues each comprise 8 levels of prioritized buffers. Queue 211 is associated with a PMD or L2 module in routing node 210 and receives data packets from switch fabric 290 and transmits data packets to external devices. Queue 212 also is associated with a PMD or L2 module in routing node 210 and receives data packets from switch fabric 290 and transmits data packets to external devices. Queue 213 is associated with an RPM or L2 module in routing node 210 and transmits data packets to switch fabric 290 and receives data packets from external devices.

Routing node 220 comprises N queues, including exemplary queues 221-223. In the exemplary embodiment, the N queues each comprise 8 levels of prioritized buffers. Queue 221 is associated with a PMD or L2 module in routing node 220 and receives data packets from switch fabric 290 and transmits data packets to external devices. Queue 222 also is associated with a PMD or L2 module in routing node 220 and receives data packets from switch fabric 290 and transmits data packets to external devices. Queue 223 is associated with an RPM or L2 module in routing node 220 and transmits data packets to switch fabric 290 and receives data packets from external devices.

Routing node 230 comprises N queues, including exemplary queues 231-233. In the exemplary embodiment, the N queues each comprise 8 levels of prioritized buffers. Queue 231 is associated with a PMD or L2 module in routing node 230 and receives data packets from switch fabric 290 and transmits data packets to external devices. Queue 232 also is associated with a PMD or L2 module in routing node 230 and receives data packets from switch fabric 290 and transmits data packets to external devices. Queue 233 is associated with an RPM or L2 module in routing node 230 and transmits data packets to switch fabric 290 and receives data packets from external devices.

Routing node 240 comprises N queues, including exemplary queues 241-243. In the exemplary embodiment, the N queues each comprise 8 levels of prioritized buffers. Queue 241 is associated with a PMD or L2 module in routing node 240 and receives data packets from switch fabric 290 and transmits data packets to external devices. Queue 242 also is associated with a PMD or L2 module in routing node 240 and receives data packets from switch fabric 290 and transmits data packets to external devices. Queue 243 is associated with an RPM or L2 module in routing node 240 and transmits data packets to switch fabric 290 and receives data packets from external devices.

According to an exemplary embodiment of the present invention, routing nodes 210, 220, 230 and 240 may process data packets using Layer 2 (L2) information (e.g., medium access control (MAC) addresses) associated with the data packets, may process data packets using Layer 3 (L3) information (e.g., Internet protocol (IP) addresses) associated with the data packets, and may process data packets using additional fields in the frame and packet headers such as packet type. Combinations of two or more of these fields may be used.

According to the exemplary embodiment, quality of service (QoS) functions are core-constrained in router 100. This forces traffic management to the input of switch fabric 290. Slowing the input of data packets to switch fabric 290 results in a slowing of the input data rate from the external network interfaces as well. Router 100 does not perform global scheduling, since global scheduling is too slow to operate at high lines rates (i.e., 10 Gbps). Also, IP Protocol does not have an admission control policy. Therefore, in an advantageous embodiment of the present invention, router 100 uses a priority-based Weighted Fair Queuing (WFQ) mechanism.

The L2 modules and RPMs (i.e., L3 modules) in routing nodes 210, 220, 230 and 240 have output buffering (e.g., queues 213, 223, 233, 243) towards switch fabric 290 and output buffering towards the network interface ports (e.g., queues 211, 212, 221, 222, 231, 232, 241, 242). As noted, in an exemplary embodiment of the present invention, each of the queues shown in FIG. 2 actually comprises a set of eight levels of prioritized buffers.

Packets received by a routing node from all external devices connected to all of its ports are placed into a single queue containing a set of eight levels of prioritized buffers. For example in router 100, routing node 210 places all of its inbound packets from external devices heading to the switch fabric into a buffer of the appropriate priority of queue 213.

At each stage of the packet transfer, the downstream device pulls packets from its ports using a prioritization scheme and the upstream device presents its highest priority packet to the downstream device. For example, switch fabric 290 pulls inbound packets from queues 213, 223, 233, and 243 using a prioritization scheme to select a queue in a routing node for each transfer and each routing node offers its highest priority packet from its prioritized buffers to switch fabric 290.

When an inbound queue (e.g., queue 213) exceeds a maximum fill level, if the protocols allow, the associated routing node (e.g., routing node 210) exerts backpressure to attempt to slow the input from the external devices, starting with the lower priority services. Otherwise, the routing node begins to drop data packets, giving precedence to dropping lower priority packets.

The packets received by routing nodes 210, 220, 230, and 240 from switch fabric 290 are placed into a single queue associated with the port. For example, routing node 210 places incoming packets from switch fabric 290 into one of the buffers of queue 211 or 212 for one of the external ports, where the buffer level is selected based on the priority of the data packet.

When a port is ready for an output packet, the routing node outputs the highest priority packet from the queue for that port. For example, when the port associated with queue 211 of routing node 210 is ready for outbound data, routing node 210 sends the highest priority packet from queue 211.

One of routing nodes 210, 220, 230 or 240 that operates as a 1 Gigabit Ethernet (1 GbE) L2 module must provide 10 Base-T, 100 Base-T, and 1000 Base-T service. In addition, the RPM/PMD module pairs in routing nodes 210, 220, 230 and 240 support configuration to data rates below the line rates. To handle these situations, a credit-based system with policing is used.

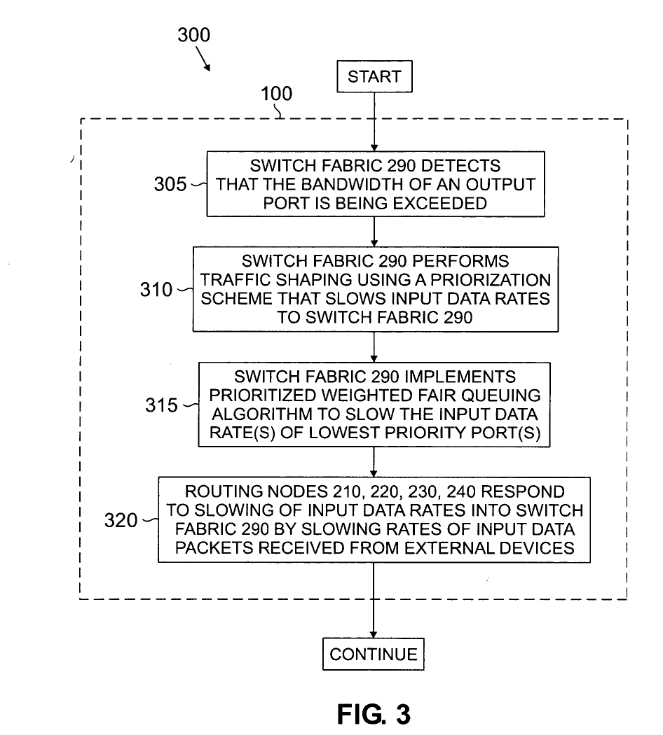

FIG. 3 depicts flow diagram 300, which illustrates traffic policing and QoS functions in exemplary router 100 according to one embodiment of the present invention. Since a 10 Gigabit module provides input data packets to a 10 Gigabit switch interface, the incoming data packets cannot overload the inputs of switch fabric 290. However, because multiple switch inputs may send data packets to the same switch output, the output bandwidth of the switch interface may be exceeded (process step 305). When this happens, it is necessary to slow the input data rates of the devices feeding the inputs of switch fabric 290. According to the principles of the present invention, switch fabric 290 accomplishes this by performing traffic shaping based on a prioritization scheme (process step 310).

According to an exemplary embodiment, switch fabric 290 may implement IEEE 802.1q/p priority queuing on all of its inputs using sophisticated L2 switching devices, such as Broadcom (BCM) 5670 devices. Some of these devices support extended protocols, such as HiGig, on their input ports. IEEE 802.1q flow control is crude, consisting of just a Stop control signal. These sophisticated L2 switching devices extend the traffic flow control through a Prioritized Weighted Fair Queuing scheme. As a result, the extended protocol slows the lowest priority port. Thus, switch fabric 290 controls incoming traffic through port prioritization (process step 315). Software must set up the queue depth value and the drop threshold value on a per port basis based on priorities using registers in the L2 switching device. Control of traffic flow is handled by hardware, based on the software register settings.

The L2 modules and RPMs (i.e., L3 modules) in routing nodes 210, 220, 230 and 240, in turn, slow the input data rates on their respective input ports when switch fabric 290 is slowing their outputs into switch fabric 290 (process step 320). Three situations arise for 10 gigagbit L2 modules, 1 gigabit L2 modules, and L3 modules. For 10 gigabit L2 modules that use use L2 devices, such as Broadcom (BCM) 5673 devices, there is a single port, so no traffic shaping or policing on a per-port basis is needed.

For L3 modules (i.e., RPMs), there may be multiple ports —sixteen for OC-12 signal, four for OC-48 signals, and one for OC-192 signals. In addition, the ports may be set to a bandwidth that is less than the maximum interface bandwidth. For these reasons, per-port traffic shaping and policing is needed. In an exemplary embodiment of the present invention, this functionality may be implemented by software in the micro-engines. Input ports are slowed based on priority, with precedence given to higher priority traffic at the port.

The software associates a set of eight levels of prioritized buffers (or eight prioritized queues) with each port. A credit-based system is used for each of the eight prioritized queues of each port. Queue sizes and thresholds are set by software based on the port bandwidth, port priority, and queue priority. Two thresholds are set on each queue. When the queue size exceeds the upper threshold, the queue loses credit and when the queue size falls below the lower threshold credit is gained. When a queue exhausts its credit, then the micro-engine stops receiving or drops data packets from the queue until it builds up credit. The credit-based system uses a long time period averaging —on the order of minutes.

For a 1 gigabit L2 module, there can be up to twelve ports. So, per-port control is desirable. Sophisticated L2 switching devices, such as Broadcom (BCM) 5693 devices, used in the 1 gigabit L2 modules support traffic shaping and policing using a credit-based system with policing. Software in the micro-engines sets up the port priorities, thresholds, and queue depth using the L2 switching device registers. Control of traffic flow is handled by hardware, based on the software register settings.

Another situation that may occur relates to exceeding the bandwidth of a network interface port on the output of router 100. In the case of a 10 gigabit L2 module, no traffic engineering on the output port is required, because the switch input interface is 10 gigabits and the port output interface is 10 gigabits.

For a twelve-port 1 gigabit Ethernet L2 module, it is possible for data packets from switch fabric 290 to exceed the output port capacity of one of the ports. Sophisticated L2 switching devices, such as BCM 5693 devices, used in the 1 gigabit L2 modules support traffic shaping and policing using a credit-based system with policing, as described above. Software in the micro-engines set up the port priorities, thresholds, and queue depth using the L2 switching device registers. Control of traffic flow is handled by hardware, based on the software register settings.

For the L3 modules (i.e., RPMs), the data packets from switch fabric 290 may exceed the configured port bandwidth allocation, as well as the physical port bandwidth. Traffic engineering is needed to hold the interface to its allocated bandwidth. This functionality may be implemented by software in the micro-engines. The micro-engine software associates a set of eight levels of prioritized buffers (or eight prioritized queues) with each port. Output ports are slowed based on port priority, queue priority, or both. A credit-based system is used for each of the eight (8) prioritized queues of each port.

Queue sizes and thresholds are set by software based on the port bandwidth, port priority, and queue priority. Two thresholds are set on each queue. When the queue size exceeds the upper threshold, the queue loses credit and when the queue size falls below the lower threshold, credit is gained. When a queue exhausts its credit, then the micro-engine stops sending or drops data packets to the port from the queue until the queue builds up credit. The credit-based system uses a long time period averaging on the order of minutes.

The present invention has numerous advantages over the prior art. Normally, in prior art routers and switches, the QoS functions are constrained by the output ports of a switch or router and traffic shaping occurs at the input ports. This requires some form of feedback for scheduling purposes and leads to head-of-line issues. However, the approach disclosed herein for router 100 is a Virtual Output Queue QoS system that constrains switch level QoS at switch fabric 290, instead of at the port outputs. Since the port performance is generally lower than switch fabric performance, port QoS is still required and is provided, using the credit-based system. The present invention combines the traffic shaping, including prioritization and QoS, into a single process handled at switch fabric 290. Traffic shaping at the input is for subscription purposes (i.e., it is done for revenue purposes).

The method according to the present invention defers the drop decision until the last moment. The drop decision is made at switch fabric 290 after the prioritization is done. With the present invention, traffic is not dropped until the congestion actually occurs at switch fabric 290 output ports. This allows the maximum bandwidth to be used, because traffic is prioritized into separate queues going into switch fabric 290 and the drop decision is made at the outputs of switch fabric 290 when the output to a port has already exceeded the port capacity.

The method according to the present invention extends the prioritization of traffic from the port level to the queue level, where multiple priorities of traffic are handled at the port. The switch mechanisms may control traffic on a per-port basis, but the method according to the present invention also allows control at a sub-port level.

The method according to the present invention is simpler because it combines traffic shaping and QoS into a single process, eliminating the need for scheduling feedback. Scheduling feedback is difficult in classic switches and routers and becomes more troublesome in distributed switches and routers. The present invention also eliminates head-of-line (HOL) issues that occur with the classic methods. The present invention allows the drop decision to be delayed until the last possible moment, thereby allowing maximum bandwidth utilization. The present invention also separates QoS issues from revenue issues, such as service contracts, thereby reducing unintended interactions between these two processes.

Although the present invention has been described with an exemplary embodiment, various changes and modifications may be suggested to one skilled in the art. It is intended that the present invention encompass such changes and modifications as fall within the scope of the appended claims.

1. A router for interconnecting external devices coupled to said router, said router comprising:
a switch fabric; and
a plurality of routing nodes coupled to said switch fabric, wherein each of said plurality of routing nodes comprises packet processing circuitry capable of transmitting data packets to, and receiving data packets from, said external devices and further capable of transmitting data packets to, and receiving data packets from, other ones of said plurality of routing nodes via said switch fabric,
wherein said switch fabric is capable of detecting that the output bandwidth of a first output of said switch fabric has been exceeded and, in response to said detection, said switch fabric causes a first one of said plurality of routing nodes to slow an input rate of data packets transmitted from said first routing node to a first input of said switch fabric.

2. The router as set forth in claim 1 wherein said switch fabric implements a Weighted Fair Queuing algorithm to slow said input rate of data packets from said first routing node.

3. The router as set forth in claim 1 wherein said first routing node comprises a first queue comprising a plurality of prioritized buffers capable of storing data packets to be transmitted to said switch fabric.

4. The router as set forth in claim 3 wherein said first routing node slows down a rate at which data packets are transmitted to said switch fabric from said first queue.

5. The router as set forth in claim 4 wherein said first routing node selects data packets to be transferred to said switch fabric from a first one of said plurality of prioritized buffers according to a priority value associated with said first prioritized buffer.

6. The router as set forth in claim 5 wherein said first routing node causes a first one of said external devices to slow a rate at which data packets are transmitted to said first queue.

7. The router as set forth in claim 3 wherein said first routing node routes said data packets using Layer 3 routing information.

8. The router as set forth in claim 7 wherein said Layer 3 routing information comprises an Internet protocol (IP) address.

9. The router as set forth in claim 3 wherein said first routing node routes said data packets using Layer 2 medium access control (MAC) address information.

10. A communication network comprising a plurality of routers that communicate data packets to one another and to interfacing external devices, each of said plurality of routers comprising:
a switch fabric; and
a plurality of routing nodes coupled to said switch fabric, wherein each of said plurality of routing nodes comprises packet processing circuitry capable of transmitting data packets to, and receiving data packets from, said external devices and further capable of transmitting data packets to, and receiving data packets from, other ones of said plurality of routing nodes via said switch fabric,
wherein said switch fabric is capable of detecting that the output bandwidth of a first output of said switch fabric has been exceeded and, in response to said detection, said switch fabric causes a first one of said plurality of routing nodes to slow an input rate of data packets transmitted from said first routing node to a first input of said switch fabric.

11. The communication network as set forth in claim 10 wherein said switch fabric implements a Weighted Fair Queuing algorithm to slow said input rate of data packets from said first routing node.

12. The communication network as set forth in claim 10 wherein said first routing node comprises a first queue comprising a plurality of prioritized buffers capable of storing data packets to be transmitted to said switch fabric.

13. The communication network as set forth in claim 12 wherein said first routing node slows down a rate at which data packets are transmitted to said switch fabric from said first queue.

14. The communication network as set forth in claim 13 wherein said first routing node selects data packets to be transferred to said switch fabric from a first one of said plurality of prioritized buffers according to a priority value associated with said first prioritized buffer.

15. The communication network as set forth in claim 14 wherein said first routing node causes a first one of said external devices to slow a rate at which data packets are transmitted to said first queue.

16. The communication network as set forth in claim 12 wherein said first routing node routes said data packets using Layer 3 routing information.

17. The communication network as set forth in claim 16 wherein said Layer 3 routing information comprises an Internet protocol (IP) address.

18. The communication network as set forth in claim 12 wherein said first routing node routes said data packets using Layer 2 medium access control (MAC) address information.

19. For use in a router comprising a switch fabric and a plurality of routing nodes, each of the routing nodes comprising packet processing circuitry for transmitting data packets to, and receiving data packets from, external devices and other routing nodes via the switch fabric, a method of routing data packets comprising the steps of:
in the switch fabric, detecting that the output bandwidth of a first output of the switch fabric has been exceeded; and
in response to the detection, causing the first routing node to slow an input rate of data packets transmitted from the first routing node to a first input of the switch fabric.

20. The method as set forth in claim 19 wherein the switch fabric implements a Weighted Fair Queuing algorithm to slow the input rate of data packets from the first routing node.

21. The method as set forth in claim 19 wherein the first routing node comprises a first queue comprising a plurality of prioritized buffers capable of storing data packets to be transmitted to the switch fabric.

22. The method as set forth in claim 21 further comprising the step of selecting data packets to be transferred to the switch fabric from a first one of the plurality of prioritized buffers according to a priority value associated with the first prioritized buffer.

23. The method as set forth in claim 22 further comprising the step of causing the first external devices to slow a rate at which data packets are transmitted to the first queue.
